(19) United States
(12) Patent Application Publication
(10) Pub. No.: US 2016/0226045 A1
(43) Pub. Date: Aug. 4, 2016

(54) METHOD FOR PRODUCING SEPARATOR, AND SAID SEPARATOR AND BATTERY USING THE SAME

(71) Applicant: Samsung SDI Co., Ltd., Yongin-si, Gyeonggi-do (KR)

(72) Inventors: Jae Hyun CHO, Suwon-si, Gyeonggi-do (KR); Kee Wook KIM, Suwon-si, Gyeonggi-do (KR); Sang Ho LEE, Suwon-si, Gyeonggi-do (KR); Jung Seong LEE, Suwon-si, Gyeonggi-do (KR); Jung Sue JANG, Suwon-si, Gyeonggi-do (KR); Jun Ho CHUNG, Suwon-si, Gyeonggi-do (KR)

(21) Appl. No.: 14/442,326

(22) PCT Filed: Aug. 30, 2013
(86) PCT No.: PCT/KR2013/007828

§ 371 Date: May 12, 2015

(30) Foreign Application Priority Data
Nov. 14, 2012 (KR) 10-2012-0128783

(51) Int. Cl. H01M 2/14; H01M 2/16; H01M 10/0525

(52) U.S. Cl. CPC H01M 2/145; H01M 10/0525; H01M 2/1653

(57) ABSTRACT

The present invention relates to a method for producing a polyolefin-based porous separator and, more particularly, to a method for producing a separator having improved tensile strength and thermal shrinkage rate by adjusting the stretching factor of a base film during the casting and stretching processes of a separator production process. Also, the present invention relates to a polyolefin-based porous separator having a small difference in tensile strength between the longitudinal direction and the transverse direction of the separator, excellent tensile strength, and improved thermal shrinkage rate and improved puncture strength. Further, the present invention relates to an electrochemical battery, of which the dimensional stability under heat and tension is improved using the separator.

### TECHNICAL FIELD

The present invention relates to a method for fabricating a separator for electrochemical batteries having excellent tensile strength, and a separator fabricated by the same. In addition, the present invention relates to an electrochemical battery including the same.

### BACKGROUND ART

A separator for electrochemical batteries refers to an intermediate membrane that isolates a cathode and an anode from each other in a battery while maintaining ionic conductivity, thereby enabling charge/discharge of the battery.

Recently, along with a trend of pursuing light weight and miniaturization of electrochemical batteries to improve portability of electronic equipment, there is a need for high-power high-capacity batteries for electric vehicles. Thus, a separator for batteries is required to have reduced thickness and weight as well as excellent dimensional stability under heat and high tension so as to improve productivity of high-capacity batteries.

To enhance dimensional stability of the separator against external impact, various studies have been made to fabricate a separator having high tensile strength. As an example of well-known techniques for improving tensile strength of the separator, Korean Patent Publication No. 10-0943235 B discloses a method wherein a high-density polyethylene composition, a molecular weight of which is regulated at a specific high level, is used in manufacture of a base film for separators, thereby providing a separator having enhanced physical strength. However, this method has a limit in that components of a base film are restricted to specific materials, and also has a problem in that the method cannot be applied to various base films.

Therefore, there is need for a method that increases tensile strength of a separator using physical approaches to be applied to various base films, instead of simply changing chemical composition of a base film to increase tensile strength as in the related art.

### DISCLOSURE

### Technical Problem

It is an aspect of the present invention to provide a separator using various base films regardless of film composition, wherein the separator has enhanced heat resistance and excellent tensile strength through adjustment of a fabrication process thereof.

Specifically, the present invention provides a method for improving tensile strength and thermal shrinkage of a separator by adjusting casting and stretching processes in a method of fabricating the separator.

It is another aspect of the present invention to provide an electrochemical battery which exhibits enhanced dimensional stability under heat and tension using a separator having excellent properties in terms of tensile strength and thermal shrinkage.

### Technical Solution

Embodiments of the present invention provide a method for improving tensile strength and thermal shrinkage of a separator by adjusting casting and stretching processes in a method of fabricating the separator.

Specifically, in accordance with one aspect of the present invention, there is provided a method of fabricating a polyolefin porous separator, including: casting a polyolefin base film; and stretching the base film in a machine direction and a transverse direction, wherein the product of the casting film forming factor and the MD stretching factor, i.e., the casting film forming factor X the MD stretching factor is 0.5 to 2.5 times the TD stretching factor.

In accordance with another aspect of the present invention, there is provided a polyolefin porous separator fabricated by the method as set forth above.

In accordance with a further aspect of the present invention, there is provided a polyolefin porous separator having a thickness of 25 μm or less, wherein each of tensile strength x of the separator in the machine direction and tensile strength y of the separator in the transverse direction is 1,500 kgf/cm² or higher, and a ratio x/y of the tensile strength x in the machine direction to the tensile strength y in the transverse direction ranges from 0.9 to 1.2.

In accordance with yet another aspect of the present invention, there is provided an electrochemical battery including the separator according to one embodiment of the present invention, a cathode, an anode, and an electrolyte.

### Advantageous Effects

The present invention relates to a method of fabricating a polyolefin porous separator, which can fabricate a separator having enhanced tensile strength and thermal shrinkage by adjusting the stretching factor of a base film in casting and stretching processes, and can be advantageously applied to a separator using various base films regardless of compositions thereof.

Further, the present invention can provide a separator that has a small difference in properties between the machine direction and the transverse direction and can thus exhibit uniform properties in either direction, and that has excellent properties in terms of overall tensile strength and thermal shrinkage, thereby suppressing internal short circuit due to internal/external shock.

In addition, the present invention can provide an electrochemical battery which uses the separator and thus exhibits improved stability and extended lifespan.

### DESCRIPTION OF DRAWINGS

FIG. 1 is a diagram illustrating a method of fabricating a separator according to one embodiment of the present invention in sequence.

FIG. 2 is a diagram illustrating casting and stretching processes of a method of fabricating a separator according to one embodiment of the present invention.

### BEST MODE

Hereinafter, exemplary embodiments of the present invention will be described in more detail. A description of details apparent to those skilled in the art will be omitted.

In accordance with one embodiment of the present invention, a method for fabricating a polyolefin porous separator includes casting a polyolefin base film and stretching the base film.

Specifically, it is possible to fabricate a separator having enhanced tensile strength and a small difference in properties between the machine direction and the transverse direction by adjusting casting and stretching processes such that the product of the casting film forming factor and the MD stretching factor of the polyolefin base film is 0.5 to 2.5 times the TD stretching factor of the polyolefin base film.

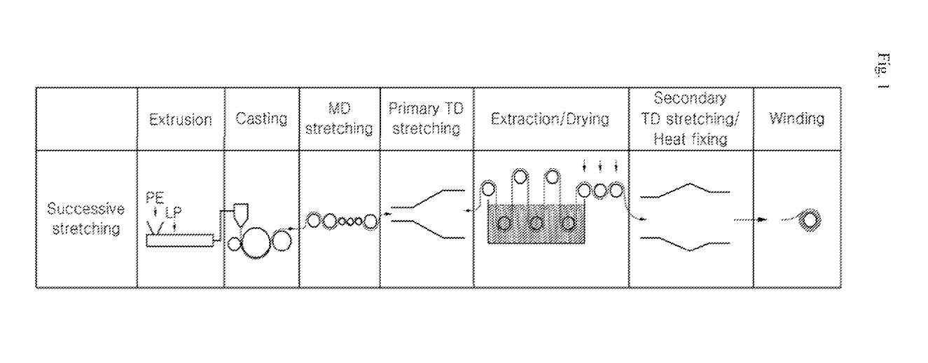

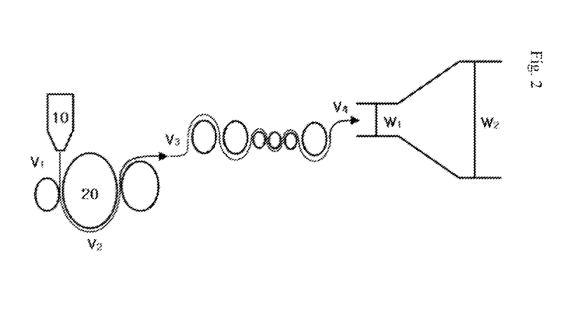

Next, the method for fabricating a polyolefin porous separator according to one embodiment of the invention will be described with reference to FIGS. 1 and 2.

Extrusion Process

First, referring to FIG. 1, a base film composition and a diluent are introduced into an extruder to be extruded (extrusion). Here, the base film composition and the diluent may be introduced into the extruder in a simultaneous or sequential manner.

The base film composition may be a polyolefin resin composition. The polyolefin resin composition may only be composed of at least one polyolefin resin, or may be a mixed composition including at least one polyolefin resin, a resin other than polyolefin resins, and/or an inorganic material.

Examples of the polyolefin resin may include polyethylene (PE), polypropylene (PP), and poly-4-methyl-1-pentene (PMP), without being limited thereto. These polyolefin resins may be used alone or in combination thereof. In other words, the polyolefin resins may be used alone or in the form of a copolymer or mixture thereof. Examples of the resin other than polyolefin resins may include polyamide (PA), polybutylene terephthalate (PBT), polyethylene terephthalate (PET), polychlorotrifluoroethylene (PCTFE), polyoxymethylene (POM), polyvinyl fluoride (PVF), polyvinylidene fluoride (PVdF), polycarbonate (PC), polyarylate (PAR), polysulfone (PSF), and polyetherimide (PEI), without being limited thereto. These resins may be used alone or in combination thereof.

Examples of the inorganic material may include alumina, calcium carbonate, silica, barium sulfate, and talc, without being limited thereto, and these inorganic materials may be used alone or as a mixture thereof.

The diluent is not particularly restricted and may be any organic compound that can form a single phase with the polyolefin resin (or the mixture of the polyolefin resin and the resin other than polyolefin resins) at an extrusion temperature. Examples of the diluent may include aliphatic or cyclic hydrocarbons such as nonane, decane, decalin, fluid paraffin (or paraffin oil) such as liquid paraffin (LP), and paraffin wax; phthalate esters such as dibutyl phthalate, dioctyl phthalate; C₁₀ to C₂₀ fatty acids such as palmitic acid, stearic acid, oleic acid, linoleic acid, and linolenic acid; and C₁₀ to C₂₀ fatty alcohols such as palmitic alcohol, stearic alcohol, and oleic alcohol, without being limited thereto. These compounds may be used alone or in combination thereof.

For example, the diluent may be fluid paraffin. Since fluid paraffin is harmless to humans, has a high boiling point, and has a low content of volatile components, the fluid paraffin is suitable for use as a diluent in a wet process.

In extrusion, the amounts of the polyolefin composition and the diluent are not particularly restricted and may be properly adjusted depending upon the intended application of a resulting sheet.

Casting (Film Forming) Process

Referring to FIGS. 1 and 2, a gel phase obtained by extrusion is casted into a sheet (film forming). Here, the stretching factor of the separator may be controlled by adjusting the casting film forming factor.

Specifically, after extrusion, a gel phase obtained through a T-die 10 may be cast into a sheet using a cooling roll 20, wherein the casting film forming factor may be controlled by adjusting the speed of the cooling roll 20.

As used herein, “the casting film forming factor” refers to a ratio of roll driving speed V₂ of casting equipment to discharging speed V₁ of the base film composition from the T-die 10, and may be represented by Equation 1:

(Casting film forming factor)=(Casting equipment roll driving speed V₂/T−die discharging speed V₁)

The casting film forming factor may range from 0.5 to 5, specifically from 1 to 5, for example, from 1 to 3.

Stretching Process

Next, after casting, the sheet is stretched.

Specifically, the solidified sheet may be stretched in the machine direction (MD) and/or in the transverse direction (TD), such as in one of the machine direction or the transverse direction (uniaxial stretching), and in both of the machine direction and the transverse direction (biaxial stretching). Further, in biaxial stretching, the cast sheet may be stretched in the machine direction and the transverse direction at the same time, or may be initially stretched in the machine direction (or transverse direction) and then stretched in the transverse direction (or machine direction).

According to one embodiment, the stretching process may be performed as biaxial stretching, specifically successive biaxial stretching in which stretching in the machine direction (or transverse direction) is initially performed, followed by stretching in the transverse direction (or machine direction). Successive biaxial stretching enables easier adjustment of stretching factor in the machine direction and the transverse direction.

In addition, successive biaxial stretching allows reduction in difference in stretching rate between a region gripped by a sheet holding device and a non-gripped region, thereby securing quality uniformity of final stretched products, and allows the sheet to be prevented from being separated from the sheet holding device, thereby ensuring production stability.

In stretching, temperature conditions may be properly adjusted to various temperature ranges, and the properties of the fabricated separator may be diversified depending on the adjusted temperature.

In this embodiment, the formed film is introduced into a stretching machine and stretched in the machine direction (MD) (MD stretching). Here, the MD stretching factor is defined as a ratio of speed V₄ at which the sheet having passed through the stretching machine is discharged from an outlet of the stretching machine to speed V₃ at which the cast sheet is introduced to an inlet of the stretching machine, as represented by Equation 2:

(MD stretching factor)=(Speed at the outlet of the stretching machine V₄/Speed at the inlet of the stretching machine V₃)

The MD stretching factor may range from 1 to 10, specifically 1 to 5.

Next, after stretching in the machine direction, the sheet is subjected to primary stretching in the transverse direction (primary TD stretching). Here, TD stretching factor is defined as a ratio of sheet width W₂ when the sheet having passed through the stretching machine is discharged from an outlet of the stretching machine to sheet width W₁ when the sheet having been stretched in the machine direction by MD stretching is introduced into an inlet of the stretching machine, as represented by Equation 3:

(TD stretching factor)=(Sheet width at the outlet of the stretching machine W₂/Sheet width at the inlet of the stretching machine W₁)

In stretching, the final stretching factor in the transverse direction may be the same as the TD stretching factor. The TD stretching factor may range from 1 to 10, specifically 4 to 9, more specifically 5 to 8.

The product of the casting film forming factor and the MD stretching factor may be 0.5 to 2.5 times, specifically 0.5 to 2 times, more specifically 1 to 2 times the TD stretching factor.

When the casting film forming factor, the MD stretching factor, the product of the casting film forming factor and the MD stretching factor, and the TD stretching factor are in the ranges set forth above, a ratio between the product of the casting film forming factor and the MD stretching factor and the TD stretching factor can be properly adjusted to reduce a difference between the MD stretching factor and the TD stretching factor of a finally produced separator, thereby providing a separator that has a small difference in tensile strength and thermal shrinkage for each direction and thus exhibits excellent dimensional stability under heat and tension.

In the method of fabricating a separator according to this embodiment, stretching is performed prior to diluent extraction, whereby the polyolefin can soften in the presence of the diluent to allow easier stretching, thereby enhancing production stability. Further, since the thickness of the sheet is reduced by stretching, the diluent can be more easily removed from the sheet during extraction after stretching.

Diluent Extraction and Drying Process

Next, the diluent is removed from the stretched film, followed by drying (extraction/drying).

Specifically, the film having been subjected to stretching in the machine direction and primary stretching in the transverse direction may be dipped in an organic solvent to extract the diluent, followed by drying through hot air drying. The solvent used in diluent extraction is not particularly restricted, and may be any typical solvent capable of extracting the diluent.

Examples of the organic solvent may include, but are not limited to, halogenated hydrocarbons such as methylene chloride, 1,1,1-trichloroethane, and fluorocarbons; hydrocarbons such as n-hexane and cyclohexane; alcohols such as ethanol and isopropanol; ketones such as acetone and 2-butanone, all of which have high extraction efficiency and can be easily dried. When fluid paraffin is used as the diluent, methylene chloride may be used as the organic solvent.

Since most organic solvents used in diluent extraction are highly volatile and toxic, water may be used to suppress volatilization of the organic solvent, as needed.

Heat Fixing and Winding Process

Next, the dried film is subjected to heat fixing while performing secondary stretching in the transverse direction (secondary TD stretching/heat fixing), followed by winding (winding).

Heat fixing is performed to remove residual stress of the dried sheet to reduce thermal shrinkage of the final sheet. Air permeability, thermal shrinkage, and strength of the separator can be adjusted depending upon the temperature and fixing rate during heat fixing.

Heat fixing may be a process in which the sheet having been subjected to diluent extraction and drying is stretched and/or relaxed (shrunk) in at least one axial direction or in both axial directions, i.e. the transverse direction and the machine direction. Specifically, heat fixing may be a process in which the sheet is stretched or relaxed in both axial directions, stretched and relaxed in both axial directions, or stretched and relaxed in one axial direction and either stretched or relaxed in the other axial direction.

For example, heat fixing may be a process in which the sheet is stretched and relaxed (shrunk) in the transverse direction, and is not particularly restricted to a certain sequence of stretching and relaxation. Specifically, after stretching in the transverse direction, the transversely stretched sheet may be relaxed in the transverse direction. Heat fixing through stretching and relaxation can improve strength of the separator while enhancing heat shrinkage of the separator, thereby providing increased heat resistance.

Specifically, during heat fixing at a temperature less than or equal to a melting point of the dried film, the dried film may be stretched in the transverse direction by a predetermined factor or may not be stretched, as needed.

In addition, during heat fixing, temperature conditions may be properly adjusted to various temperature ranges, and the properties of the fabricated separator can be varied depending on the adjusted temperature.

Further, heat fixing may be performed in a tenter; transverse stretching and/or transverse relaxation may be properly repeated more than once depending upon desired strength and heat shrinkage of the separator; and secondary stretching factor in the transverse direction may be arbitrarily adjusted depending upon application of the film.

In accordance with another aspect of the present invention, there is provided a polyolefin porous separator having a thickness of 25 μm or less, wherein each of tensile strength x of the separator in the machine direction and tensile strength y of the separator in the transverse direction is 1,500 kgf/cm² or higher, and a ratio x/y of the tensile strength x in the machine direction to the tensile strength y in the transverse direction ranges from 0.9 to 1.2.

Specifically, the tensile strength x in the machine direction and/or the tensile strength y in the transverse direction of the separator may be 1600 kgf/cm² or higher. Further, the ratio of tensile strength may range from 1.0 to 1.2.

Thus, the separator according to embodiments of the invention has a considerably small difference in properties between the machine direction and the transverse direction, thereby ensuring uniform properties in either direction.

Further, in fabrication of the separator, tensile strength of the separator may be adjusted by varying the stretching factor. Specifically, the separator fabricated according to one embodiment of the invention has enhanced heat shrinkage and puncture strength by reducing a difference between tensile strength in the machine direction and tensile strength in the transverse direction in casting and stretching, thereby exhibiting improved stability.

Tensile strength of the separator may be measured by any method typically used in the art. A non-limiting example of the method for measuring tensile strength of the separator is as follows. The fabricated separator is cut into a rectangular shape having a size of 10 mm×50 mm (length (MD)×width (TD)) at 10 different regions, thereby obtaining 10 specimens. Each of the specimens is mounted on a tensile tester UTM and gripped to have a measuring length of 20 mm, followed by measurement of average tensile strength in the machine direction and the transverse direction while applying a pulling force to the specimen.

In this aspect, the separator may have a puncture strength of 600 gf or higher.

The puncture strength is a measure denoting hardness of the separator, and may be measured using any method generally used in the art. A non-limiting example of the method for measuring puncture strength is as follows. The fabricated separator is cut into a size of 50 mm×50 mm (length (MD)×width (TD)) at 10 different regions, thereby obtaining 10 specimens. Next, each of the specimens is placed over a hole having a diameter of 10 cm using a strength tester GATO TECH G5 equipment (Gato tech Co., Ltd), followed by measuring puncturing force three times for each specimen while pressing down using a probe having a diameter of 1 mm and then averaging.

In this aspect, the separator may have a thermal shrinkage of 4% or less in both of the machine direction and the transverse direction, as measured after being left at 105° C. for 1 hour. Specifically, the separator may have a thermal shrinkage of 4% or less in the machine direction and 3% or less in the transverse direction, more specifically 3.5% or less in the machine direction and 2.5% or less in the transverse direction.

Further, the separator may have a thermal shrinkage of 5% or less in both of the machine direction and the transverse direction, as measured after being left at 120° C. for 1 hour. Specifically, the separator may have a thermal shrinkage of 4% or less in the machine direction and 3% or less in the transverse direction.

Thus, the separator according to embodiments of the invention has excellent heat resistance, thereby effectively preventing short circuit of electrodes and improving stability of a resultant battery.

In addition, a difference between thermal shrinkage as measured after leaving the separator at 105° C. for 1 hour and thermal shrinkage as measured after leaving the separator at 120° C. for 1 hour may be 3% or less, for example, 2% or less, in each of the machine direction and the transverse direction. Such a small difference in thermal shrinkage with temperature in either axial direction allows the separator to exhibit enhanced resistance to thermal shrinkage caused by overheating of a battery, thereby providing excellent properties in terms of shape preservation and stability to the battery.

Thermal shrinkage of the separator may be measured using any method generally used in the art.

A non-limiting example of the method for measuring the thermal shrinkage of the separator is as follows. The fabricated separator is cut into a size of 50 mm×50 mm (length (MD)×width (TD)) at 10 different regions, thereby obtaining 10 specimens. Next, each of the specimens is left in an oven at 105° C. or at 120° C. for 1 hour, followed by measuring the degree of shrinkage in the MD and the TD, and then calculating average thermal shrinkage.

Further, the polyolefin porous separator fabricated by the method according to one embodiment of the present invention may have an air permeability of 300 sec/100 cc or less, specifically 280 sec/100 cc or less.

Thus, the separator prepared according to embodiments of the invention has enhanced air permeability as well as excellent heat resistance and small difference in properties according to directions.

Air permeability of the separator may be measured using any method generally used in the art. A non-limiting example of the method for measuring air permeability is as follows. The fabricated separator is cut at 10 different regions, thereby obtaining 10 specimens. Next, average time for a circular area of the separator having a diameter of 1 inch to transmit 100 cc of air is measured five times for each specimen using an air permeability measuring instrument (Asahi Seiko Co., Ltd.), followed by averaging to find air permeability.

In accordance with a further aspect of the present invention, there is provided an electrochemical battery which includes a polyolefin porous separator, a cathode, and an anode and is filled with an electrolyte. The polyolefin porous separator may be a separator prepared using the method as set forth above, or the separator as set forth above.

The electrochemical battery is not particularly restricted in terms of kind thereof and may be any typical battery known in the art.

The electrochemical battery may be a lithium secondary battery, such as a lithium metal secondary battery, a lithium ion secondary battery, a lithium polymer secondary battery, or a lithium ion polymer secondary battery.

The electrochemical battery may be fabricated using any method typically used in the art without particular limitation. A non-limiting example of the electrochemical battery fabrication method is as follows. The polyolefin separator including an organic/inorganic complex coating layer is interposed between the cathode and the anode of the battery, followed by filling the battery with the electrolyte.

Electrodes constituting the electrochemical battery may be prepared in the form of an electrode current collector with an electrode active material applied thereto using a typical method known in the art.

Among the electrode active materials used in the invention, a cathode active material may be any cathode active material generally used in the art without limitation.

Examples of the cathode active material may include, but are not limited to, lithium manganese oxide, lithium cobalt oxide, lithium nickel oxide, lithium iron oxide, and lithium complex oxides obtained by combination thereof.

Among the electrode active materials used in the present invention, an anode active material may be any anode active material generally used in the art.

Examples of the anode active material may include lithium adsorption materials such as a lithium metal or lithium alloy, carbon, petroleum coke, activated carbon, graphite, and other carbons, without being limited thereto.

The electrode current collectors may be any electrode current collector generally used in the art.

Examples of materials for a cathode current collector of the electrode current collectors may include a foil made of aluminum, nickel, and combinations thereof, without being limited thereto.

Examples of materials for an anode current collector of the electrode current collectors may include a foil made of copper, gold, nickel, copper alloys, and combinations thereof, without being limited thereto.

The electrolyte may be any electrolyte for electrochemical batteries generally used in the art.

The electrolyte may be an electrolyte obtained by dissolution or dissociation of a salt having a structure such as A⁺B⁻ in an organic solvent.

Examples of A⁺ may include, but are not limited to, an alkali metal cation such as Li⁺, Na⁺, or K⁺ and a cation obtained by combination thereof.

Examples of B⁻ may include, but are not limited to, an anion such as PF₆⁻, BF₄⁻, Cl⁻, Br⁻, I⁻, ClO₄⁻, AsF₆⁻, CH₃CO₂⁻, CF₃SO₃⁻, N(CF₃SO₂)₂⁻, or C(CF₂SO₂)₃⁻ and an anion obtained by combination thereof.

Examples of the organic solvent may include propylene carbonate (PC), ethylene carbonate (EC), diethyl carbonate (DEC), dimethyl carbonate (DMC), dipropyl carbonate (DPC), dimethyl sulfoxide (DMSO), acetonitrile, dimethoxyethane, diethoxyethane, tetrahydrofuran (THF), N-methyl-2-pyrrolidone (NMP), ethyl methyl carbonate (EMC), and γ-butyrolactone (GBL), without being limited thereto. These organic solvents may be used alone or as mixtures thereof.

Next, the present invention will be described in more detail with reference to examples, comparative examples, and experimental examples. However, it should be noted that these examples, comparative examples, and experimental examples are provided for illustration only and should not be construed in any way as limiting the invention.

### Example 1

30 parts by weight of high-density polyethylene having a weight average molecular weight (Mw) of 600,000 g/mol (HDPE; Mitsui Chemical) was supplied to a twin screw extruder and 70 parts by weight of fluid paraffin (SC Chemicals) was then introduced into the twin screw extruder, followed by extrusion.

After extrusion, a gel phase obtained through a T-die is fabricated into a sheet-form separator using a cooling roll. In fabrication of the sheet, casting was performed with the speed of the cooling roll adjusted for the casting equipment film forming factor to be 1. Next, the sheet was stretched for the MD stretching factor to be 5, and then subjected to primary TD sthe stretching factor to be 5.

The stretched polyethylene base film was washed with methylene chloride (Samsung Fine Chemical) to extract the fluid paraffin, followed by drying. Next, the dried film was subjected to secondary stretching in the transverse direction while performing heat fixing, followed by winding, thereby fabricating a polyolefin porous separator having a thickness of 16 μm.

### Example 2

A polyolefin porous separator was prepared in the same manner as in Example 1 except that the casting film forming factor, the MD stretching factor, and the TD stretching factor were set to 2, 4, and 6.25, respectively.

### Example 3

A polyolefin porous separator was prepared in the same manner as in Example 1 except that the casting equipment film forming factor, the MD stretching factor, and the TD stretching factor were set to 3, 4, and 8, respectively.

### Comparative Example 1

A polyolefin porous separator was prepared in the same manner as in Example 1 except that the casting film forming factor was set to 3.

### Comparative Example 2

A polyolefin porous separator was prepared in the same manner as in Example 1 except that the casting film forming factor and the TD stretching factor were set to 4 and 6, respectively.

### Comparative Example 3

A polyolefin porous separator was prepared in the same manner as in Example 1 except that the casting film forming factor, the MD stretching factor, and the TD stretching factor were set to 1, 3, and 8, respectively.

In preparation of the separators in Examples 1 to 3 and Comparative Examples 1 to 3, the stretching factors and thickness of each of the separators are shown in Table 1.

TABLE 1

| | | | | Comparative | Comparative | Comparative |
|---|---|---|---|---|---|---|
| Item | Example 1 | Example 2 | Example 3 | Example 1 | Example 2 | Example 3 |
| Casting film forming | 1 | 2 | 3 | 3 | 4 | 1 |
| factor (x) | | | | | | |
| MD stretching factor (y) | 5 | 4 | 4 | 5 | 5 | 3 |
| x × y | 5 | 8 | 12 | 15 | 20 | 3 |
| TD stretching factor | 5 | 6.25 | 8 | 5 | 6 | 8 |
| Thickness of separator | 16 | 16 | 16 | 16 | 16 | 16 |
| (μm) | | | | | | |

### Experimental Example 1

### Measurement of Air Permeability of Separator

To measure air permeability of the separators prepared in Examples 1 to 3 and Comparative Examples 1 to 3, the following experiment was conducted.

Each of the separators prepared in Examples and Comparative Examples was cut into a size capable of accommodating a circle having a diameter of 1 inch or greater at 10 different regions, thereby obtaining 10 specimens. Then, time for each specimen to transmit 100 cc of air was measured 5 times using an air permeability measurement instrument (Asahi Seiko Co., Ltd), followed by averaging to find air permeability.

### Experimental Example 2

### Measurement of Puncture Strength of Separator

To measure puncture strength of the separators prepared in Examples 1 to 3 and Comparative Examples 1 to 3, the following experiment was conducted.

Each of the separators prepared in Examples and Comparative Examples was cut into a size of 50 mm×50 mm (length (MD)×width (TD)) at 10 different regions, thereby obtaining 10 specimens. Next, each of the specimens was placed over a hole having a diameter of 10 cm using a strengthtester (GATO TECH G5 equipment: Gato tech Co., Ltd), followed by measuring puncturing force three times for each specimen while pressing down using a probe having a diameter of 1 mm and then averaging.

### Experimental Example 3

### Measurement of Tensile Strength of Separator

To measure tensile strength of the separators prepared in Examples 1 to 3 and Comparative Examples 1 to 3, the following experiment was conducted.

Each of the separators prepared in Examples and Comparative Examples was cut into a rectangular shape having a size of 10 mm×50 mm (length (MD)×width (TD)) at 10 different regions, thereby obtaining 10 specimens. Each of the specimens was mounted on a universal testing machine UTM and held in place for the measuring length to be 20 mm, followed by measurement of average tensile strength in the machine direction (MD) and the transverse direction (TD) while applying a pulling force to the specimen.

### Experimental Example 4

### Measurement of Thermal Shrinkage of Separator

To measure thermal shrinkage of the separators prepared in Examples 1 to 3 and Comparative Examples 1 to 3, the following experiment was conducted.

Each of the separators prepared in Examples and Comparative Examples was cut into a size of 50 mm×50 mm (length (MD)×width (TD)) at 10 different regions, thereby obtaining 10 specimens. Each specimen was left in an oven at 105° C. and at 120° C. for 1 hour, followed by measuring thermal shrinkage in the machine direction (MD) and the transverse direction (TD), thereby calculating average thermal shrinkage.

Measurement results according to Experimental Examples 1 to 4 are shown in Table 2.

TABLE 2

| | | | | | | Comparative | Comparative | Comparative |
|---|---|---|---|---|---|---|---|---|
| Item | | | Example 1 | Example 2 | Example 3 | Example 1 | Example 2 | Example 3 |
| Air permeability (sec/100 cc) | | | 270 | 240 | 200 | 320 | 300 | 560 |
| Puncture strength (gf) | | | 600 | 620 | 650 | 510 | 530 | 320 |
| Tensile strength | | MD | 1650 | 1750 | 1900 | 2000 | 2300 | 780 |
| (kgf/cm²) | | TD | 1600 | 1600 | 1800 | 1300 | 1400 | 1500 |
| Thermal Shrinkage | 105° C., | MD | 3.0 | 3.0 | 3.5 | 4.0 | 5.0 | 1.0 |
| (%) | 1 hr | TD | 1.0 | 1.5 | 2.0 | 3.5 | 4.0 | 6.5 |
| | 120° C., | MD | 4.0 | 4.0 | 5.0 | 6.0 | 7.0 | 1.5 |
| | 1 hr | TD | 2.0 | 2.5 | 2.5 | 5.0 | 6.5 | 9.0 |

### LEGEND OF REFERENCE NUMERALS

10 T-die
20 Cooling roll of casting equipment
V₁ discharging speed from T-die
V₂ Roll driving speed of casting equipment
V₃ Speed at inlet of stretching machine
V₄ Speed at outlet of stretching machine
W₁ Sheet width at inlet of stretching machine
W₂ Sheet width at outlet of stretching machine

1. A method of fabricating a polyolefin porous separator, comprising:
casting a polyolefin base film; and
stretching the base film in a machine direction (MD) and a transverse direction (TD),
wherein the product of a casting film forming factor and a MD stretching factor of the polyolefin base film is 0.5 to 2.5 times a TD stretching factor of the polyolefin base film.

2. The method as claimed in claim 1, wherein the product of the casting film forming factor and the MD stretching factor is 1 to 2 times the TD stretching factor.

3. The method as claimed in claim 1, wherein the casting film forming factor ranges from 0.5 to 5.

4. The method as claimed in claim 1, wherein the MD stretching factor ranges from 1 to 10.

5. The method as claimed in claim 1, wherein the TD stretching factor ranges from 1 to 10.

6. (canceled)

7. A polyolefin porous separator having a thickness of 25 μm or less, wherein each of tensile strength x of the separator in a machine direction and tensile strength y of the separator in a transverse direction is 1,500 kgf/cm² or higher, and a ratio x/y of the tensile strength x in the machine direction to the tensile strength y in the transverse direction ranges from 0.9 to 1.2.

8. The polyolefin porous separator as claimed in claim 7, wherein the separator has a puncture strength of 600 gf or higher.

9. The polyolefin porous separator as claimed in claim 7, wherein thermal shrinkage of the separator as measured after leaving the separator at 105° C. for 1 hour is 4% or less in each of the machine direction (MD) and the transverse direction (TD).

10. The polyolefin porous separator as claimed in claim 7, wherein a difference between thermal shrinkage of the separator as measured after leaving the separator at 105° C. for 1 hour and thermal shrinkage of the separator as measured after leaving the separator at 120° C. for 1 hour is 3% or less in each of the machine direction and the transverse direction.

11. The polyolefin porous separator as claimed in claim 7, wherein thermal shrinkage of the separator as measured after leaving the separator at 120° C. for 1 hour is 5% or less in each of the machine direction and the transverse direction.

12. The polyolefin porous separator as claimed in claim 7, wherein the separator has an air permeability of 300 sec/100 cc or less.

13. The polyolefin porous separator as claimed in claim 7, wherein the separator is fabricated by the method as claimed in claim 1.

14. An electrochemical battery, comprising:
a cathode; an anode; a separator, and an electrolyte, wherein:
the separator is a polyolefin porous membrane having a thickness of 20 μm or less;
each of tensile strength x of the separator in a machine direction and tensile strength y of the separator in a transverse direction is 1,500 kgf/cm² or higher; and
a ratio x/y of the tensile strength x in the machine direction to the tensile strength y in the transverse direction ranges from 0.9 to 1.2.

15. The electrochemical battery as claimed in claim 14, wherein the separator is fabricated by the method as claimed in claim 1.

16. The electrochemical battery as claimed in claim 14, wherein the electrochemical battery is a lithium secondary battery.
